(19) United States
(12) Patent Application Publication
(10) Pub. No.: US 2004/0261273 A1
(43) Pub. Date: Dec. 30, 2004

(54) Drive mechanism and power tool

(76) Inventors: David B. Griep, Rubicon, WI (US); Richard H. Jungmann, Richfield, WI (US); Roger D. Neitzell, North Prairie, WI (US); Thomas P. James, Oconomowoc, WI (US); Thomas R. Bednar, Pewaukee, WI (US); Troy Charles Thorson, Waukesha, WI (US)

Correspondence Address: MICHAEL BEST & FRIEDRICH, LLP, 100 E WISCONSIN AVENUE, MILWAUKEE, WI, 53202, US

(21) Appl. No.: 10/602,210

(22) Filed: Jun. 24, 2003

(51) Int. Cl. B27B 5/29

(52) U.S. Cl. 30/392

(57) ABSTRACT

A drive mechanism for a power tool, a power tool and a reciprocating saw. The power tool includes a housing, a motor supported by the housing and including a drive shaft, an output member supported by the housing and adapted to support a tool element, and a drive mechanism. The drive mechanism includes a drive assembly driven by the drive shaft for rotation about an axis, the drive assembly including a gear, a hub selectively driven by the gear for rotation about the axis, and structure positioned between the gear and the hub, the structure selectively transmitting drive force between the gear and the hub and selectively allows relative movement between the gear and the hub. The drive mechanism may also include a drive arm drivingly connected between the drive assembly and the output member of a tool, and the drive arm may be configured to absorb an impact.

### FIELD OF THE INVENTION

The present invention relates to drive mechanisms and, more particularly, to a drive mechanism for a power tool.

### BACKGROUND OF THE INVENTION

A power tool, such as, for example, a reciprocating saw, generally includes a housing supporting a motor, an output member adapted to support a tool element and a drive mechanism to drive the output member. In the reciprocating saw, the motor and the drive mechanism operate to reciprocate a spindle and a saw blade supported by the spindle.

### SUMMARY OF THE INVENTION

During operation, as the spindle and saw blade are reciprocated, the saw blade may be pinched or bind in the workpiece or may strike a solid object, preventing the saw blade from reciprocating. The sudden stopping of the tool element or saw blade can damage the spindle, the drive mechanism and/or the motor.

The present invention provides, among other things, a drive mechanism, a power tool and a reciprocating saw which substantially alleviates one or more of the above-described and other independent problems with existing drive mechanisms, power tools and reciprocating saws. In some aspects, the present invention provides a drive mechanism generally including structure to allow relative movement of components of the drive mechanism to, for example, absorb an impact on the tool element or on the output member. In some aspects, the present invention provides a drive mechanism generally including an elastic member allowing relative movement of components of the drive mechanism to, for example, absorb an impact.

More particularly, the present invention provides a drive mechanism for a power tool, the power tool generally including a motor including a drive shaft and an output member adapted to support a tool element. The drive mechanism generally includes a drive assembly engaged with and driven by the drive shaft, and a drive arm drivingly connected between the drive assembly and the output member to transmit driving force from the drive assembly to the output member. The drive arm is configured to absorb an impact.

In one construction, the drive assembly includes a gear rotatably driven about an axis by the drive shaft and drivingly connected to the drive arm. In another construction, the drive arm connects the gear to the output member to convert the rotation of the gear to reciprocation of the output member. In another construction, the drive assembly also includes a hub selectively driven by the gear and an elastic member positioned between the gear and hub to absorb the impact.

In one construction, the drive arm has a first portion and a second portion, one of the first portion and the second portion being a flexible portion. In another construction, the flexible portion is configured to absorb the impact and includes a flexible member. In another construction, the drive arm further includes a third portion, and the flexible member is located between the second portion and the third portion. In another construction, the second and third portions are interlocked to limit the amount of deflection generated in the arm. In another construction, the flexible portion has flexure points to create an area of deformation to absorb the impact. In another construction; the power tool is a reciprocating saw, and the drive arm absorbs impact resulting from a blade lock-up.

Also, the present invention provides a drive mechanism for a power tool, the power tool including a motor including a drive shaft and an output member adapted to support a tool element. The drive mechanism generally includes a gear driven by the drive shaft for rotation about an axis, a hub selectively driven by the gear for rotation about the axis, the hub being movable relative to the gear, the hub driving the output member, and structure positioned between the gear and the hub, the structure selectively transmitting drive force from the gear to the hub and selectively allowing relative movement between the gear and the hub.

In one construction, the drive shaft supports a pinion, and the gear has an outer periphery defining teeth, the teeth preferably being engaged with and driven by the pinion to rotate the gear about the axis. In another construction, the hub is rotatable about the axis relative to the gear and may have a drive member offset from the axis and connected to the output member to drivingly connect the hub to the output member. In another construction, the drive mechanism may further comprise a drive arm connecting the drive member to the output member to convert rotation of the hub to reciprocation of the output member.

In one construction, the structure includes an elastic member. The gear may define a pocket and includes a gear protrusion in the pocket, and a portion of the hub may be supported in the pocket and includes a hub protrusion, the gear protrusion drivingly engaging the hub protrusion. In one construction, at least a portion of the elastic member is positioned between the gear protrusion and the hub protrusion. In another construction, the structure is a slip clutch.

In some constructions, the power tool is a reciprocating saw, the output member is a reciprocatable spindle, and the tool element is a saw blade operable to cut a workpiece. In such constructions, the structure preferably absorbs impact resulting from a blade lock-up.

In addition, the present invention provides a power tool comprising a housing, a motor supported by the housing and having a drive shaft, an output member supported by the housing and adapted to support a tool element, and a drive mechanism supported by the housing and operable to drive the output member. The drive mechanism generally includes a gear driven by the drive shaft for rotation about an axis, a hub selectively driven by the gear for rotation about the axis, the hub being movable relative to the gear, and structure positioned between the gear and the hub, the structure selectively transmitting drive force from the gear to the hub and selectively allowing relative movement between the gear and the hub.

Further, the present invention provides a reciprocating saw comprising a housing, a motor supported by the housing and having a drive shaft, a spindle supported by the housing and adapted to support a saw blade, and a drive mechanism supported by the housing and operable to drive the spindle. The drive mechanism generally includes a gear driven by the drive shaft for rotation about an axis, a hub selectively driven by the gear for rotation about the axis, the hub being movable relative to the gear, and a structure to absorb impact positioned between the gear and the hub, the structure selectively transmitting drive force from the gear to the hub and allowing relative movement between the gear and the hub to absorb an impact on the spindle.

Independent features and independent advantages of the present invention will become apparent to those skilled in the art upon review of the following detailed description, claims and drawings.

### BRIEF DESCRIPTION OF THE DRAWINGS

FIG. 1 is a side partial cross-sectional view of a reciprocating saw embodying aspects of the invention.

FIG. 2 is a side partial cross-sectional view of a portion of the drive mechanism shown in FIG. 1.

FIG. 3 is a cross-sectional view taken generally along line 3—3 in FIG. 2.

FIG. 4 is a cross-sectional view taken generally along line 4—4 in FIG. 2.

FIG. 5 is an exploded perspective view of a portion of the drive mechanism shown in FIG. 1.

FIG. 6 is a plan view of the drive mechanism gear and hub components.

FIG. 7 is a side partial cross-sectional view of an alternative construction of a reciprocating saw embodying aspects of the invention.

FIG. 8 is a side partial cross-sectional view of another alternative construction of a reciprocating saw embodying aspects of the invention.

FIG. 9 is an exploded view of an alternative drive arm according to FIG. 8.

FIG. 10 is a cross-sectional view taken generally along line 10-10 of FIG. 8.

FIG. 11 is a cross sectional view taken generally along line 11-11 of FIG. 10.

FIG. 12 is a side cross-sectional view of an alternative construction of a reciprocating saw embodying aspects of the invention.

FIG. 13 is a top cross-sectional view of the reciprocating saw shown in FIG. 12, illustrating the slip clutch.

FIG. 14 is a partial top view showing the slip clutch of FIG. 13 in greater detail.

FIG. 15 is an exploded view of the slip clutch of FIG. 13.

Before at least one embodiment of the invention is explained in detail, it is to be understood that the invention is not limited in its application to the details of the construction and the arrangements of the components set forth in the following description or illustrated in the drawings. The invention is capable of other embodiments and of being practiced or carried out in various ways. Also, it is understood that the phraseology and terminology used herein is for the purpose of description and should not be regarded as limiting.

### DETAILED DESCRIPTION

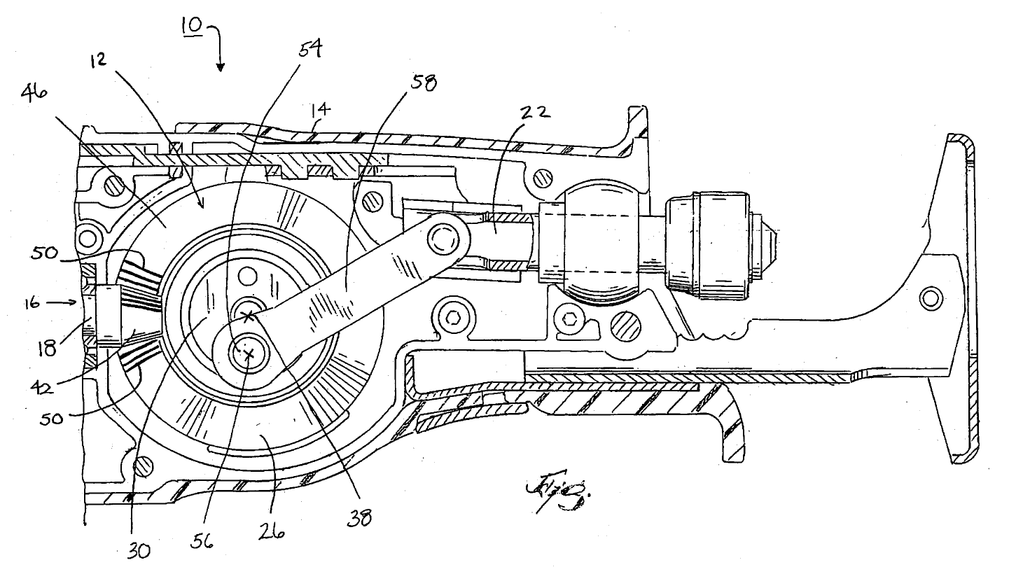

A power tool, such as, for example, a reciprocating saw 10, and a drive mechanism 12 embodying the invention are illustrated in FIG. 1. It should be understood that, for some aspects of the invention and in some constructions (not shown), the power tool may be another type of power tool, such as, for example, a hammer, rotary hammer, circular saw, drill, etc.

As shown in FIG. 1, the reciprocating saw 10 includes a housing 14 that supports a motor 16 (partially shown). The motor 16 includes a drive shaft 18 that engages the drive mechanism 12 to drive an output member or spindle 22. In the illustrated construction, the spindle 22 is supported by the housing 14 for generally reciprocating movement and is adapted to support a tool element, such as a saw blade (not shown). It should be understood that the spindle 22 may be supported and driven to also partially move in a direction transverse to the axis of reciprocation to provide, for example, orbital motion or rocking motion, of the spindle 22 and saw blade.

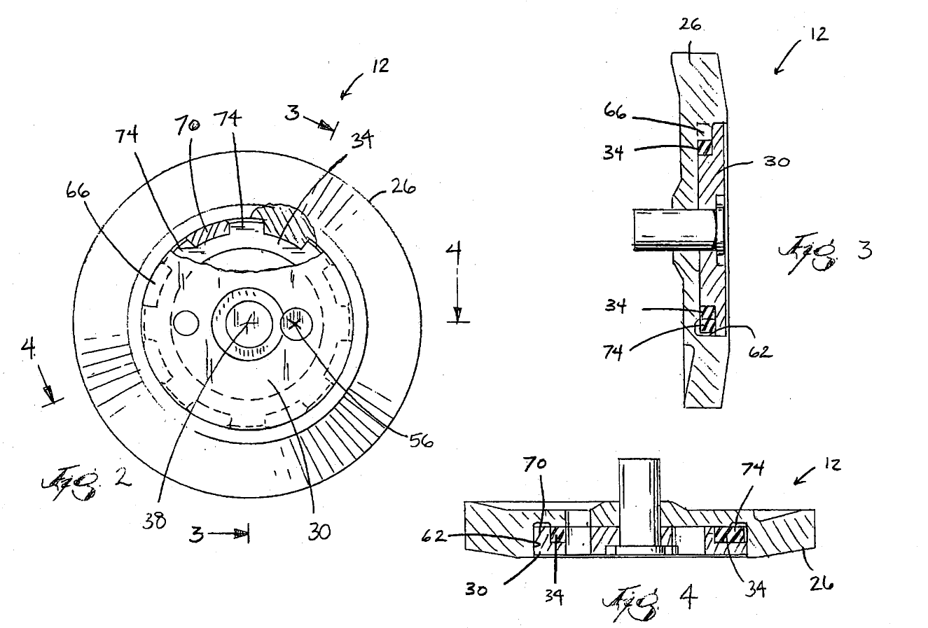

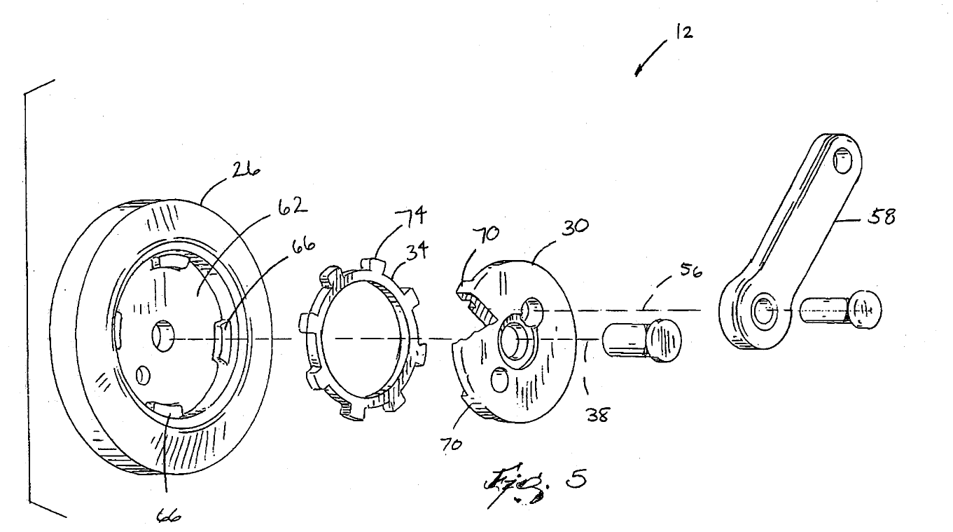

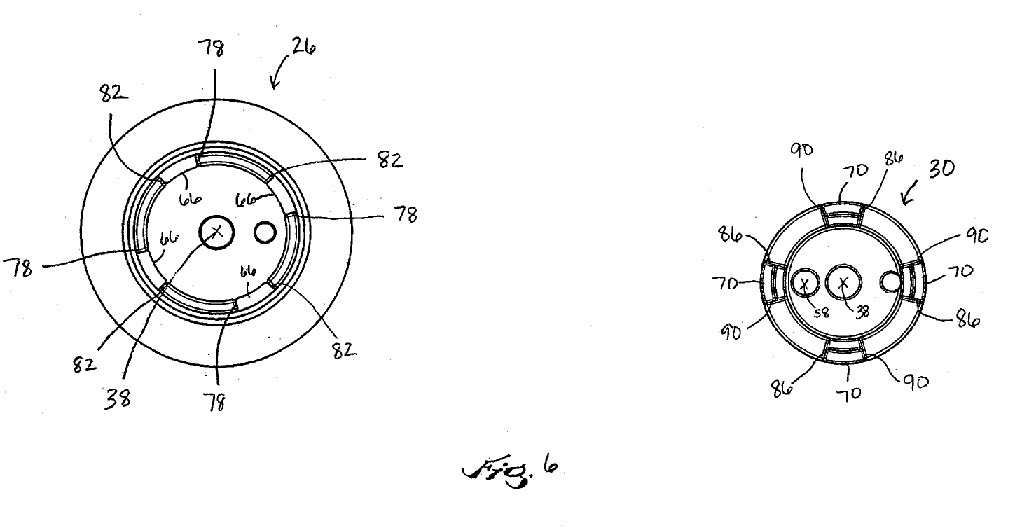

The drive mechanism 12 includes a gear 26, a hub 30 and (see FIGS. 2-5) and structure, such as an elastic member 34, at least partially between (in a force-transmitting and/or positional sense) the gear 26 and the hub 30. As shown in FIG. 1, the drive shaft 18 drives the gear 26 for rotation about an axis 38. The gear 26 selectively drives the hub 30 for rotation about axis 38. The hub 30 is supported for movement, such as, for example, limited pivoting or rotational movement about the axis 38, relative to the gear 26. As explained below in more detail, the hub 30 drives the spindle 22. As shown in FIGS. 2-5, the elastic member 34 is positioned at least partially between (in the illustrated construction, in both a force-transmitting and positional sense) the gear 26 and the hub 30 to selectively transmit drive force from the gear 26 to the hub 30 and to selectively allow relative movement between the gear 26 and the hub 30 to, for example, absorb an “impact” on the spindle 22 or saw blade.

As used herein, an “impact” may result from relative movement or forces tending to cause relative movement between components of the drive arrangement (i.e., the motor 16, the drive mechanism 12, etc.). Such relative movement may be undesirable and may wear and/or damage the components. For example, an impact may occur if the tool element binds on a workpiece (i.e., a saw blade being pinched by the workpiece) or strikes an obstacle while the drive mechanism 12 and/or the motor 16 continue to apply a drive force. An impact may also occur if the output element is stopped because it strikes an obstacle or due to friction between the spindle 22 and the spindle support while the motor 16 continues to apply driving force. In addition, an impact may occur if the motor 16 is stopped while the inertia of the drive mechanism 12 and/or the driven mechanism (i.e., the output element and/or the tool element) continues movement of these components.

As shown in FIG. 1, the drive shaft 18 supports a pinion 42. The gear 26 includes an outer periphery 46 defining teeth 50, and the pinion 42 engages the teeth 50 to rotate the gear 26 about the axis 38. The hub 30 includes a drive member 54 offset from axis 38 and defining an eccentric axis 56. A drive arm 58 is connected between the drive member 54 and the spindle 22 and drivingly connects the hub 30 to the spindle 22 to convert rotational movement of the hub 30 into generally reciprocating movement of the spindle 22.

A more detailed illustration of the drive mechanism 12 is shown in FIGS. 2-5. In the illustrated construction, the gear 26 defines a pocket 62 and includes at least one and, in the illustrated construction, four gear protrusions 66. In the illustrated construction, a portion of the hub 30 is supported in the pocket 62. The hub 30 includes at least one and, in the illustrated construction, four hub protrusions 70. The gear protrusion 66 selectively drivingly engages the hub protrusion 70 (through the elastic member 34), transmitting driving force from the gear 26 to the hub 30 and causing rotation of the hub 30 with the gear 26.

It should be understood that, in some constructions (not shown), the gear 26 may not define a pocket 62, and the hub 30 may not be positioned in such a pocket. In such constructions, the gear 26 and the hub 30 may be positioned in axial face-to-face relation. It should also be understood that, in some aspects and in some constructions (not shown), substantially all of the hub 30 may be positioned in the pocket 62.

In the illustrated constructions, the gear protrusions 66 and the hub protrusions 70 are generally the same size and generally equally spaced apart. It should be understood that in some constructions (not shown), the gear protrusions 66 and the hub protrusions 70 may be of different sizes and may be spaced apart unequally.

At least a portion of the elastic member 34 is positioned between the gear 26 and the hub 30 to selectively transmit driving force from the gear 26 to the hub 30 and to selectively allow relative movement between the gear 26 and the hub 30 to, for example, absorb an impact on the spindle 22 or on the saw blade. In the illustrated construction, the elastic member 34 includes a body and at least one and, in the illustrated construction, eight elastic member protrusions 74 connected to the body. Preferably, an elastic member protrusion 74 is positioned between each adjacent gear protrusion 66 and hub protrusion 70.

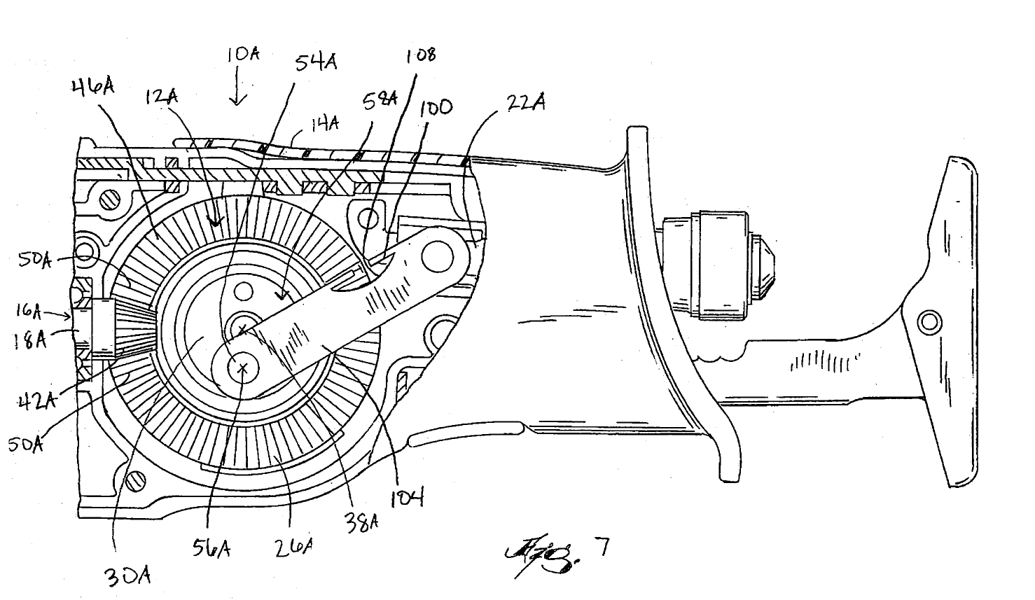

As shown in FIG. 6, each gear protrusion 66 includes a gear protrusion first side 78 and a gear protrusion second side 82, and each hub protrusion 70 includes a hub protrusion first side 86 and a hub protrusion second side 90. In the illustrated construction, an elastic member protrusion 74 is positioned circumferentially between a gear protrusion first side 78 and a hub protrusion first side 86, and another elastic member protrusion 74 is positioned circumferentially between a gear protrusion second side 82 and a hub protrusion second side 90.

It should be understood that, in some constructions (not shown), the elastic member 34 may not include a body but may include separate, independent elastic members (similar to the elastic member protrusions 74) between adjacent gear protrusions 66 and hub protrusions 70. In some other constructions (not shown), fewer than all of the elastic member protrusions 74 may be connected to a body portion, and the remaining elastic member portions 74 may be connected to another body portion, or may be separate from and independent of a body portion.

In the illustrated construction, the elastic member 34 is formed of rubber. In other constructions, the elastic member 34 may be formed of another elastomeric material, such as, for example, silicone, neoprene, nitrile, EPDM, or polymers of various durometer. Also, in other constructions (not shown), the elastic member 34 may have a geometry and/or construction providing the necessary characteristics, such as elasticity, resiliency, etc. (i.e., a cut-out portion).

In operation, under normal conditions, when the motor 16 is operated, the drive shaft 18 rotates the gear 26, and the gear 26 rotates the hub 30 (through the elastic member 34). Eccentric rotation of the drive member 54 and the resulting motion of the drive arm 58 causes reciprocation of the spindle 22 (and of the saw blade). At start-up and during operation, the elastic member 34 may be initially slightly compressed to a driving force-transmitting condition.

If the saw blade and/or the spindle 22 is stopped suddenly (i.e. because of an impact), the hub 30 may be slowed (relative to the rotational speed of the gear 26) or may stop rotating. If the motor 16 continues to operate, the drive shaft 18 continues to rotate the gear 26. In such a condition, the elastic member 34 allows relative rotational movement between the rotating gear 26 and the slowed or stopped hub 30. Each elastic member protrusion 74 is compressed to an impact-absorbing condition between each adjacent gear protrusion 66 and hub protrusion 70. The elastic member 34 thus operates to absorb the impact to prevent wear or damage to the components of the reciprocating saw 10 (including the drive mechanism 12 and the motor 16). After the impact is absorbed, the elastic member 34 returns to its original uncompressed condition or to the slightly compressed driving-force transmitting condition.

While, in the illustrated construction, the elastic member 34 is compressed to absorb an impact, it should be understood that, in other constructions (not shown), the elastic member 34 may be arranged to be in tension, torsion, etc. to absorb the impact.

It should be understood that the term “elastic” is a relative term. In the illustrated construction, the elastic member 34 is sufficiently rigid to transmit driving force between the gear 26 and the hub 30 and sufficiently flexible to accommodate some relative movement between the gear 26 and the hub 30 to, for example, absorb an impact. Also, in the illustrated construction, the elastic member 34 is sufficiently resilient to substantially (and, preferably, repeatedly) return to its original shape after operation and after absorbing an impact.

In other constructions (not shown), the structure between the gear 26 and the hub 30 may include another type of elastic member, such as a spring. Such a spring may be a compression, tension or torsion spring, formed of, for example, spring steel. The structure may include yet other types of elastic members, such as, for example, air-damped shock absorbers, fluid-damped systems, etc.

It should be understood that, in some constructions (not shown), the structure between the gear 26 and the hub 30 may include flexible and/or flexibly-mounted gear protrusions (not shown) and/or hub protrusions (not shown) on the gear 26 and on the hub 30, respectively. In such constructions (not shown), the gear protrusions and/or the hub protrusions selectively transmit the drive force and selectively allow the relative movement between the gear 26 and the hub 30.

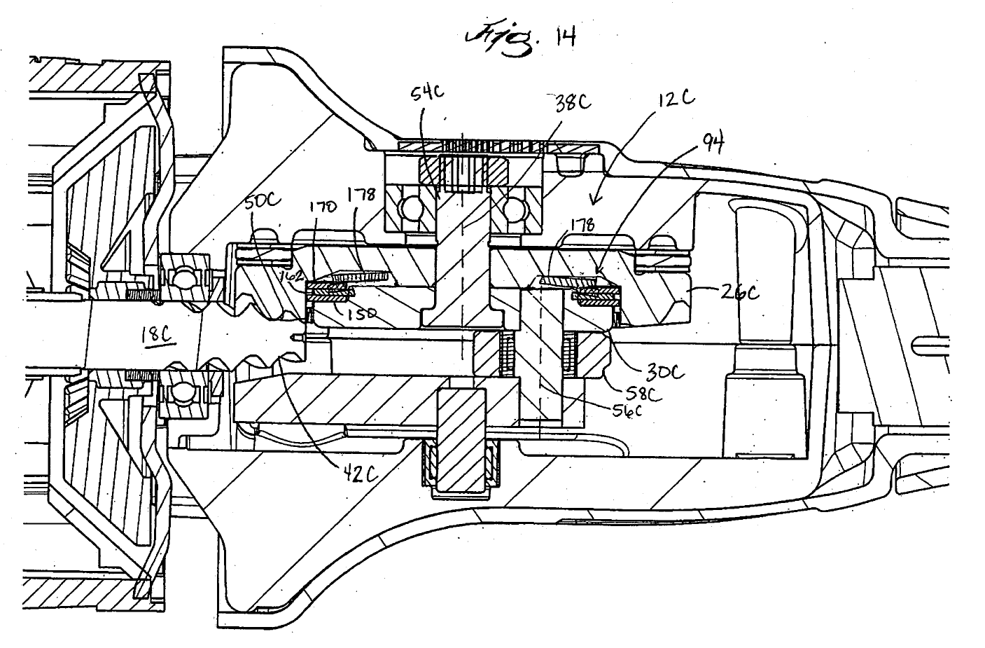

It should also be understood that, for some aspects of the invention and in some constructions (such as the constructions shown in FIGS. 12-15), the structure between the gear 26 and the hub 30 may be between the gear 26 and the hub 30 in only a force-transmitting sense. Such structure may be provided by a slip clutch 94 between the gear 26 and the hub 30 (see FIG. 13). The details of the slip clutch 94 will be described in detail below with respect to FIGS. 12-15.

In addition, it should be understood that, for some aspects of the invention and in some constructions (not shown), the structure between the gear 26 and the hub 30 may include another drive arrangement (not shown) between the gear 26 and the hub 30. For example, a frictional drive arrangement may be provided between (in both a force-transmitting and positional sense) the gear 26 and the hub 30, and relative movement of the gear 26 and the hub 30 may occur if a force is applied to overcome this frictional engagement.

In the construction illustrated in FIGS. 1-6, the structure transmits drive force between the gear 26 and the hub 30 in both directions of rotation about the axis 38. Also, in the illustrated construction, the structure transmits substantially the same force (i.e., allows relative movement of the gear 26 and the hub 30 at substantially the same opposing force threshold or impact force) in both rotational directions. In other constructions (not shown), the structure may transmit drive force and/or allow relative movement between the gear 26 and the hub 30 in only one rotational direction (i.e., impact absorption provided in only a “forward” drive direction and not in an opposite “reverse” drive direction). In other constructions (not shown), the structure may transmit different forces in the opposite rotational directions (i.e., a different “impact” force required for relative movement of the gear 26 and the hub 30).

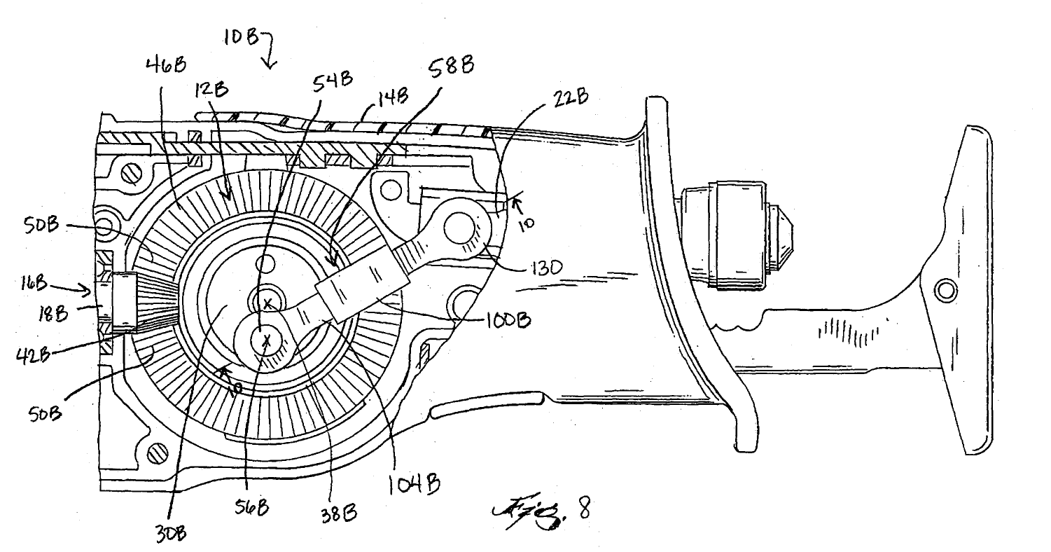

In other constructions, another component of the drive mechanism may be configured to absorb impact. For example, a reciprocating saw 10A including a drive mechanism 12A with an impact-absorbing drive arm 58A is illustrated in FIG. 7. Common elements are identified by the same reference number “A”.

As shown in FIG. 7, the drive mechanism 12A includes the drive arm 58A connected between a drive member 54A and the spindle 22A. In the illustrated construction, the drive arm 58A includes a first portion 100 and a second portion 104, and one of the first portion 100 and the second portion 104 (e.g. the first portion 100) is a flexible portion. In the illustrated construction, the flexible portion 100 includes flexure points 108 formed in the drive arm 58A that allow for compression and/or movement to absorb impact in the drive mechanism 12A.

As shown in FIG. 7, the flexure point 108 is a cut-out area of known geometry to allow for a generally known amount of deflection. However, in other constructions (not shown), the flexure point 108 may be provided by a reduced thickness portion of the drive arm 58A that allows for deflection in the drive arm 58A. In yet other constructions (not shown), the flexible portion 100 may be provided by a flexure point 108 cut out of the drive arm 58A which is then filled with a flexible member. In such constructions, the flexible member (not shown) may be formed of a different material than the second portion 104 such as, for example, elastomeric material, rubber, silicone, neoprene, etc.

In the illustrated construction, the drive arm 58A drivingly connects a hub 30A to the spindle 22A to convert rotational movement of the hub 30A into generally reciprocating movement of the spindle 22A. It should be understood that the drive arm 58A can be utilized with a gear and hub drive mechanism 12 (as described above for FIGS. 1-6), a scotch yoke drive mechanism, a wobble plate drive mechanism, or other drive mechanism. Also, it should be understood that the drive arm 58A could be used with the construction illustrated in FIGS. 1-6, or with the construction illustrated in FIGS. 12-14 for greater impact absorption.

FIG. 8 illustrates another construction of a reciprocating saw 10B including a drive mechanism 12B with an impact-absorbing drive arm 58B. Common elements are identified by the same reference number “B”.

As shown in FIG. 8, the drive mechanism 12B includes the drive arm 58B that is configured to absorb impact on the drive mechanism 12B. As illustrated, the drive arm 58B includes a first portion 100B, a second portion 104B, and a third portion 130. In the illustrated construction, the first portion 100B is a flexible member and is located between the second portion 104B and the third portion 130. The flexible member 100B may be insert molded between the second portion 104B and third portion 130. As illustrated, the flexible member 100B is formed of a different material than the second portion 104B and the third portion 130 such as, for example, elastomeric material, rubber, or the like. By varying the material used to form the flexible member 100B, varying amounts of impact absorption can be achieved within the drive mechanism 12B. Further as illustrated, the second portion 104B and the third portion 130 are formed of relatively non-flexible material, although it should be understood that the second portion 104B and/or the third portion 130 may be formed of flexible material as well.

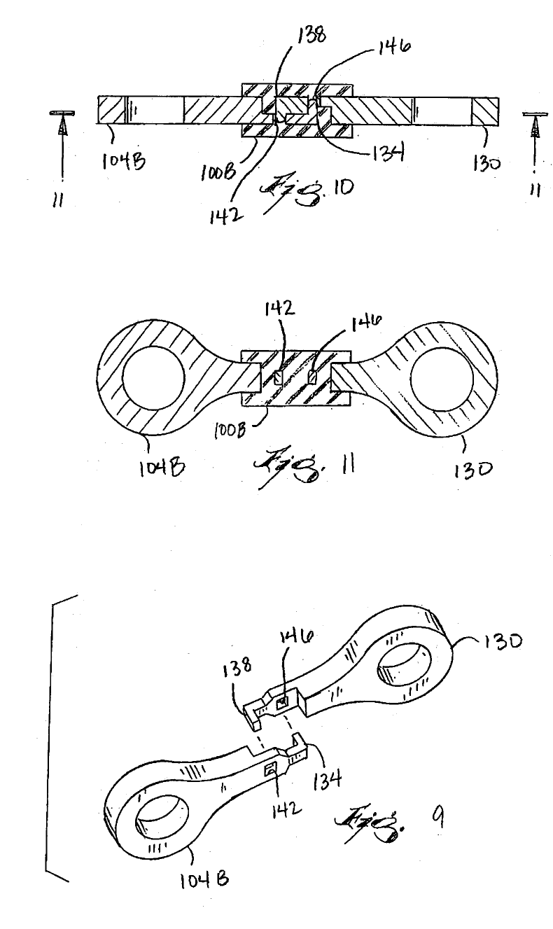

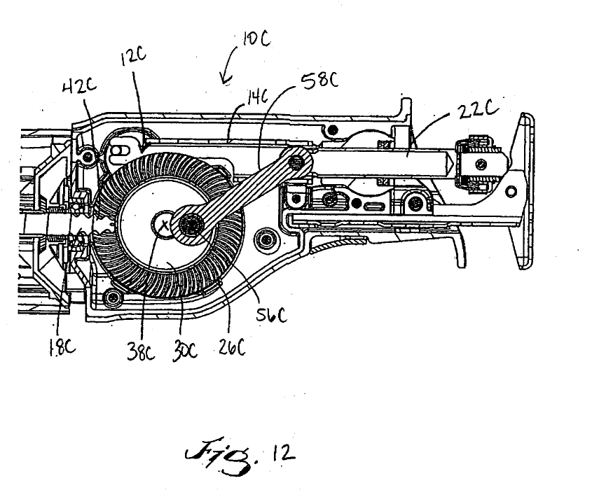

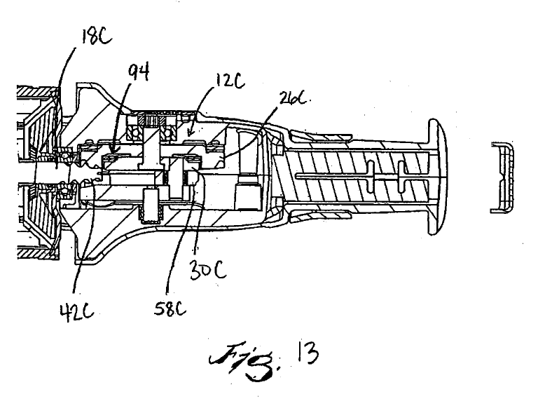

As illustrated in FIGS. 9-11, the second portion 104B and third portion 130 can be interlocking to limit the amount of deflection through the assembly of the drive arm 58B. With reference to FIG. 9, the second portion 104B includes a hook 134 that interacts with a similar hook 138 on the third portion 130. The first portion 100B may be molded over the hooks 134, 138 to provide a flexible member to allow for impact absorption in the drive mechanism 12B, and the interaction of the hooks 134, 138 limits the amount of deflection (compression, tension, and/or torsion) in the drive arm 58B to provide for a relatively stable drive arm 58B. As illustrated, each hook 134, 138 includes an aperture 142, 146 for receiving the end of the opposing hook 138, 134 thus interlocking the hooks 134, 138 together.

FIGS. 12-15 illustrate a reciprocating saw 10C including a drive mechanism 12C embodying aspects of the invention. Common elements are referred to by the same reference number “C”.

As shown in FIGS. 12-14, the drive mechanism 12C includes a gear 26C, a hub 30C, and a slip clutch 94 at least partially between the gear 26C and the hub 30C. The slip clutch 94 is positioned at least partially between the gear 26C and the hub 30C to selectively transmit drive force from the gear 26C to the hub 30C and to selectively allow relative movement between the gear 26C and the hub 30C to, for example, absorb an impact on the spindle 22C or the blade (not shown). As described above with respect to FIGS. 2-5, the gear 26C drives the hub 30C, which in turn drives the spindle 22C.

In the illustrated construction, a drive arm 58C is connected between the drive member 54C and the spindle 22C to covert the rotational motion of the hub 30C into generally reciprocating motion of the spindle 22C. It is understood that the drive arm 58C may be the drive arm 58 as described above with respect to FIGS. 2-5, the drive arm 58A as described with respect to FIG. 7, the drive arm 58B as described with respect to FIG. 8, or any other suitable drive arm configuration.

FIG. 15 illustrates the slip clutch 94 in more detail. The function of the slip clutch is described in U.S. Pat. No. 5,689,891, issued Nov. 25, 1997 to Bednar, et al., the entire contents of which is incorporated herein by reference.

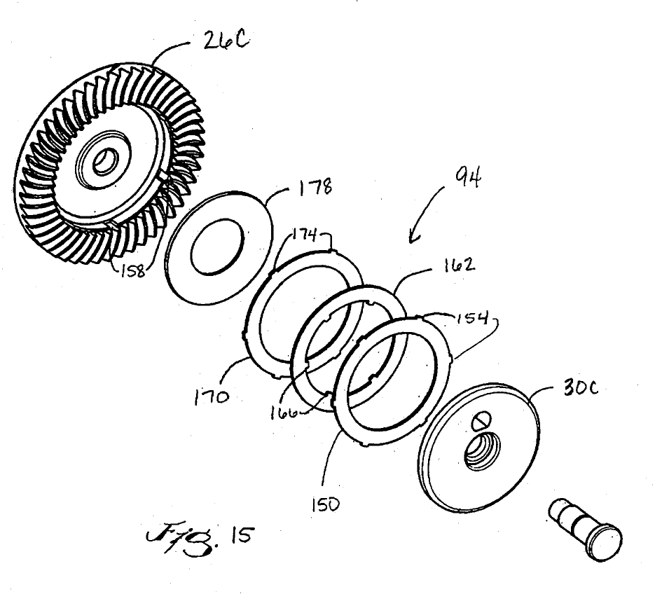

The slip clutch 94 includes a plurality of clutch disks 150, 162, 170 positioned between the gear 26C and the hub 30C. A first clutch disk 150 includes a plurality of radially-outwardly projecting splines 154 that cooperate with corresponding axially-extending grooves 158 on the inner surface of the gear 26C. Similarly, a third clutch disk 170 has corresponding radially-outwardly projecting splines 174 that cooperate with the grooves 158 on the gear 26C. A second clutch disk 162 is sandwiched between the first and third clutch disks 150, 170 and includes a plurality of radially-inwardly projecting splines 166 that cooperate with corresponding axially-extending grooves (see FIG. 14) on the hub 30C. By providing three clutch disks 150, 162, 170, the illustrated slip clutch 94 provides four friction surfaces. It should be understood that in other constructions (not shown), the slip clutch 94 may have fewer clutch disks or may even include no clutch disks, in which case the slip clutch would comprise the frictional engagement between the gear 26C and the hub 30C.

The slip clutch 94 also includes a disk spring 178 that biases the clutch disks 150, 162, 170 together and then allows slippage if there is binding of the spindle 22C. The disk spring 178 also controls the frictional engagement between the gear 26C and the hub 30C. The clutch 94 will slip when the load on the spindle 22C (or on the motor 16C) exceeds the force applied by the disk spring 178, and the friction between the gear 26C, hub 30C, and clutch disks 150, 162, 170. More particularly, the clutch disks 150, 162, 170 will slip relative to either or both of the gear 26C and the hub 30C to absorb an impact.

It should be understood that, for some aspects of the invention and in some constructions (not shown), the drive mechanism 12 may be another type of drive mechanism, such as, for example, a rotary-to-rotary motion drive mechanism. It should also be understood that, for some aspects of the invention and in some constructions (not shown), the drive mechanism 12 may be used with another driven mechanism in equipment other than power tools, such as, for example, compressors, engines, motors, pneumatic tools, appliances, hydraulic motors, generators, etc.

One or more of the above-identified and other independent features or independent advantages of the invention are set forth in the following claims.

We claim:

1. A drive mechanism for a power tool, the power tool including a motor including a drive shaft and an output member adapted to support a tool element, the drive mechanism comprising:
a drive assembly engaged with and driven by the drive shaft; and
a drive arm drivingly connected between the drive assembly and the output member to transmit driving force from the drive assembly to the output member, the drive arm being configured to absorb an impact.

2. The drive mechanism as set forth in claim 1, wherein the drive assembly includes a gear rotatably driven about an axis by the drive shaft and drivingly connected to the drive arm.

3. The drive mechanism as set forth in claim 2, wherein the drive assembly includes a drive member supported by the gear and offset from the axis, the drive member being connected to the drive arm to drivingly connect the gear to the drive arm.

4. The drive mechanism as set forth in claim 2, wherein the drive arm connects the gear to the output member to convert rotation of the gear to reciprocation of the output member.

5. The drive mechanism as set forth in claim 2, wherein the drive assembly further includes
a hub selectively driven by the gear, the hub rotatable about the axis relative to the gear, and
an elastic member positioned between the gear and the hub to absorb the impact.

6. The drive mechanism set forth in claim 1, wherein the drive arm has a first portion and a second portion, one of the first portion and the second portion being a flexible portion.

7. The drive mechanism set forth in claim 6, wherein the flexible portion is configured to absorb the impact.

8. The drive mechanism set forth in claim 7, wherein the flexible portion includes a flexible member.

9. The drive mechanism set forth in claim 8, wherein the flexible member is connected to the other of the first portion and the second portion.

10. The drive mechanism set forth in claim 8, wherein the flexible member is formed of a different material than the other of the first portion and the second portion.

11. The drive mechanism set forth in claim 10, wherein the flexible member is formed of an elastomeric material.

12. The drive mechanism set forth in claim 10, wherein the flexible member is formed of rubber.

13. The drive mechanism set forth in claim 8, wherein the drive arm further includes a third portion, and wherein the flexible member is located between the third portion and the other of the first portion and the second portion.

14. The drive mechanism set forth in claim 13, wherein the third portion and the other of the first portion and the second portion are interlocked to limit the amount of deflection generated in the drive arm.

15. The drive mechanism set forth in claim 14, wherein the other of the first portion and the second portion is connected to the drive assembly, and wherein the third portion is connected to the output member.

16. The drive mechanism set forth in claim 6, wherein the flexible portion has a flexure point to create an area of deformation to absorb the impact.

17. The drive mechanism set forth in claim 16, wherein the flexure point is provided by a cut-out area.

18. The drive mechanism as set forth in claim 1, wherein the power tool is a reciprocating saw, wherein the output member is a reciprocatable spindle, wherein the tool element is a saw blade operable to cut a workpiece, and wherein the drive arm absorbs an impact resulting from a blade lock-up.

19. A reciprocating saw comprising:
a housing;
a motor supported by the housing and having a drive shaft;
a spindle supported by the housing and adapted to support a saw blade; and
a drive mechanism supported by the housing and operable to drive the spindle, the drive mechanism including
a drive assembly engaged with and driven by the drive shaft, and
a drive arm drivingly connected between the drive assembly and the spindle to transmit driving force from the drive assembly to the spindle, the drive arm being configured to absorb an impact.

20. A drive mechanism for a power tool, the power tool including a motor including a drive shaft and an output member adapted to support a tool element, the drive mechanism comprising:
a gear driven by the drive shaft for rotation about an axis;
a hub selectively driven by the gear for rotation about the axis, the hub being movable relative to the gear, the hub including a drive member offset from the axis and connected to the output member to drivingly connect the hub to the output member;
a drive arm connecting the drive member to the output member to convert rotation of the hub to reciprocation of the output member; and
structure positioned between the gear and the hub, the structure selectively transmitting drive force from the gear to the hub and selectively allowing relative movement between the gear and the hub.

21. The drive mechanism as set forth in claim 20, wherein the drive shaft supports a pinion, and wherein the gear has an outer periphery defining teeth, the teeth being engaged with and driven by the pinion to rotate the gear about the axis.

22. The drive mechanism as set forth in claim 20, wherein the hub is rotatable about the axis relative to the gear.

23. The drive mechanism as set forth in claim 20, wherein the structure includes an elastic member.

24. The drive mechanism as set forth in claim 23, wherein the gear defines a pocket and includes a gear protrusion in the pocket, and wherein a portion of the hub is supported in the pocket and includes a hub protrusion, the gear protrusion drivingly engaging the hub protrusion.

25. The drive mechanism as set forth in claim 24, wherein at least a portion of the elastic member is positioned between the gear protrusion and the hub protrusion.

26. The drive mechanism as set forth in claim 25, wherein the gear protrusion includes a first side and a second side, wherein the hub protrusion includes a first side and a second side, and wherein the elastic member includes a first elastic member protrusion positioned between the gear protrusion first side and the hub protrusion first side and a second elastic member protrusion positioned between the gear protrusion second side and the hub protrusion second side.

27. The drive mechanism as set forth in claim 24, wherein the gear includes a plurality of gear protrusions, and wherein the hub includes a plurality of hub protrusions.

28. The drive mechanism as set forth in claim 27, wherein the elastic member includes a plurality of elastic member protrusions, each one of the plurality of elastic member protrusions being positioned between an adjacent one of the plurality of gear protrusions and of the plurality of hub protrusions.

29. The drive mechanism as set forth in claim 28, wherein the elastic member includes a body, and wherein the plurality of elastic member protrusions are connected to the body.

30. The drive mechanism as set forth in claim 28, wherein the gear includes four gear protrusions, wherein the hub includes four hub protrusions, and wherein the elastic member includes eight elastic member protrusions.

31. The drive mechanism as set forth in claim 23, wherein the elastic member is formed of rubber.

32. The drive mechanism as set forth in claim 23, wherein the elastic member is formed of an elastomeric material.

33. The drive mechanism as set forth in claim 20, wherein the power tool is a reciprocating saw, wherein the output member is a reciprocatable spindle, wherein the tool element is a saw blade operable to cut a workpiece, and wherein the structure absorbs impact resulting from a blade lock-up.

34. The drive mechanism as set forth in claim 20, wherein the structure is a slip clutch.

35. The drive mechanism as set forth in claim 34, wherein the slip clutch includes a plurality of clutch disks, and wherein two of the clutch disks are driven by the gear and another of the clutch disks is driven by the hub and is sandwiched between the clutch disks that are driven by the gear.

36. A power tool comprising:
a housing;
a motor supported by the housing and having a drive shaft;
an output member supported by the housing and adapted to support a tool element; and
a drive mechanism supported by the housing and operable to drive the output member, the drive mechanism including
a gear driven by the drive shaft for rotation about an axis,
a hub selectively driven by the gear for rotation about the axis, the hub being movable relative to the gear, and
structure positioned between the gear and the hub, the structure selectively transmitting drive force from the gear to the hub and selectively allowing relative movement between the gear and the hub.

37. The power tool as set forth in claim 36, wherein the structure includes an elastic member.

38. The power tool as set forth in claim 36, wherein the gear defines a pocket and includes a gear protrusion in the pocket, and wherein a portion of the hub is supported in the pocket and includes a hub protrusion, the gear protrusion drivingly engaging the hub protrusion, and wherein at least a portion of the elastic member is positioned between the gear protrusion and the hub protrusion.

39. A reciprocating saw comprising:
a housing;
a motor supported by the housing and having a drive shaft;
a spindle supported by the housing and adapted to support a saw blade; and
a drive mechanism supported by the housing and operable to drive the spindle, the drive mechanism including
a gear driven by the drive shaft for rotation about an axis,
a hub selectively driven by the gear for rotation about the axis, the hub being movable relative to the gear, and
structure to absorb impact positioned between the gear and the hub, the structure selectively transmitting drive force from the gear to the hub and allowing relative movement between the gear and the hub to absorb an impact on the spindle.

40. The reciprocating saw as set forth in claim 39, wherein the structure is an elastic member.

41. The reciprocating saw as set forth in claim 40, wherein the gear defines a pocket and includes a gear protrusion in the pocket, wherein a portion of the hub is supported in the pocket and includes a hub protrusion, the gear protrusion drivingly engaging the hub protrusion, and wherein at least a portion of the elastic member is positioned between the gear protrusion and the hub protrusion.

42. A reciprocating saw comprising:
a housing;
a motor supported by the housing and having a drive shaft;
a spindle supported by the housing and adapted to support a saw blade; and
a drive mechanism supported by the housing and operable to drive the spindle, the drive mechanism including
a gear driven by the drive shaft for rotation about an axis
a hub selectively driven by the gear for rotation about the axis, the hub being movable relative to the gear,
a drive member connected to the hub offset from the axis and connected to the spindle to drivingly connect the hub to the spindle,
a drive arm connecting the drive member to the spindle to convert rotation of the hub to reciprocation of the spindle, and
a slip clutch positioned between the gear and the hub, the slip clutch selectively transmitting drive force from the gear to the hub and allowing relative movement between the gear and the hub to absorb and impact on the spindle.

43. The reciprocating saw as set forth in claim 42, wherein the slip clutch includes a plurality of clutch disks, and wherein two of the clutch disks are driven by the gear and another of the clutch disks is driven by the hub and is sandwiched between the clutch disks that are driven by the gear.
